(19) United States
(12) Patent Application Publication
(10) Pub. No.: US 2025/0233539 A1
(43) Pub. Date: Jul. 17, 2025

(54) System and Method for Node Management in an Independent Cart System

(71) Applicant: Rockwell Automation Technologies, Inc., Mayfield Heights, OH (US)

(72) Inventors: Peter Eric Malkowski, Lancaster, MA (US); Brian M. Perreault, Stow, MA (US); Yuhong Huang, Acton, MA (US)

(21) Appl. No.: 18/415,283

(22) Filed: Jan. 17, 2024

(51) Int. Cl. H02P 25/064; B65G 54/02

(52) U.S. Cl. CPC H02P 25/064; B65G 54/02

(57) ABSTRACT

A method for node management in an independent cart system receives a path command at a controller for the independent cart system. The path command defines a desired motion for a mover in the independent cart system. The path command spans at least one transfer segment and multiple fixed track segments. Each of the fixed track segments has a predefined flow, and the transfer segment has a dynamic flow. A single direction of travel is defined within the controller corresponding to the desired motion for the mover. A motion command corresponding to the desired motion for the mover is transmitted to each of the fixed track segments. The dynamic flow is set for the transfer segment to the single direction, and a motion command is transmitted to the transfer segment as a function of the dynamic flow for the transfer segment and of the desired motion for the mover.

### BACKGROUND INFORMATION

The subject matter disclosed herein relates to a system and method for managing motion of vehicles in an independent cart system. More specifically, each track segment has a predefined positive and negative direction of travel. The subject matter disclosed herein provides management of traffic flow at nodes where a positive direction of travel flows into a negative direction of travel.

Motion control systems utilizing independent cart technology employ a linear drive system embedded within a track and multiple vehicles, also referred to as “movers” or carts, that are propelled along the track via the linear drive system. Movers and linear drive systems can be used in a wide variety of processes (e.g. packaging, manufacturing, and machining) and can provide an advantage over conventional conveyor belt systems with enhanced flexibility, extremely high-speed movement, and mechanical simplicity. The independently controlled movers or carts are each supported on a track for motion along the track. The track is made up of a number of track segments that, in turn, hold individually controllable electric coils. Successive activation of the coils establishes a moving electromagnetic field that interacts with the movers and causes the mover to travel along the track. Sensors may be spaced at fixed positions along the track and/or on the movers to provide information about the position and speed of the movers. Each of the movers may be independently moved and positioned along the track in response to the electromagnetic fields generated by the coils.

Linear drive systems are controlled similar to a rotary motor in which a stator is unrolled onto a flat surface and the rotor travels along the coils of the stator. Additional coils are added along the flat surface to extend the length of travel for each rotor. In a rotary motor, a current is regulated within the stator to generate a moving electromagnetic field rotating around the motor. Permanent magnets mounted in the rotor generate a magnetic field that interacts with the moving electromagnetic field to cause rotation of the motor. Regulating current in a first direction in a rotary motor causes the electromagnetic field to rotate around the motor in the first direction and, subsequently, causes the rotor to follow and rotate the motor in the first direction. Regulating current in a second direction, opposite the first direction, in a rotary motor causes the electromagnetic field to rotate around the motor in the second direction and, subsequently, causes the rotor to follow and rotate the motor in the second direction. In the same manner, regulating current in the coils of the linear drive system in a first direction along the track, causes the electromagnetic field generated by the current to move in the first direction along the track. Permanent magnets mounted on each vehicle generate a magnetic field that interacts with the moving electromagnetic field to propel the vehicle along the track in the first direction. Regulating current in the coils of the linear drive system in a second direction, opposite the first direction, along the track, causes the electromagnetic field generated by the current to move in the second direction along the track. The magnetic field generated by the permanent magnets mounted on each vehicle interacts with the moving electromagnetic field to propel the vehicle along the track in the second direction.

Each track in the independent cart system includes a plurality of track segments, and each track segment includes a portion of the coils for the linear drive system. Further, each track segment includes a controller configured to regulate current in the coils present on the corresponding track segment. In order to regulate current in the coils, each track segment must define one direction as positive and one direction as negative. For uniformity, each track segment will define the positive and negative directions in the same manner. In other words, a first track segment defines the positive direction as extending from a first end of the first track segment toward a second end of the first track segment. A second track segment, with its first end placed adjacent to the second end of the first track segment, similarly defines the positive direction from a first end of the second track segment toward a second end of the second track segment. Each successive track segment is placed with its first end adjacent to a second end of a prior track segment and defines the positive direction as extending from the first end to the second end of the corresponding track segment.

However, as motion control systems utilizing independent cart technology grow more complex, uniformly defining directions from one end of track segment to the other end of the track segment is not without certain challenges. Certain applications include track switches which allow vehicles to travel between two different paths in one track or between two different tracks. Further, vehicles which travel along a length of a track must return to the beginning to repeatedly travel along the length of the track. In some applications, a track may form a closed loop, providing a defined return path from the end of a track back the beginning of the track. On a closed loop, the direction of each track segment may be continuously defined in the same direction and allow vehicles to continuously travel along the loop. However, in other applications, the length of the track may make it impractical to define an entirely separate return path for vehicles. It may be necessary to have a loop which routes vehicles back along the same track on which they initially travelled. In other applications, the number of paths and potential interconnections between paths make it impossible to define a continuous direction of travel. In such applications, one track segment having a positive direction of travel in one direction must abut another track segment having a positive direction of travel in the opposite direction.

Historically, a transition between track segments having opposite directions of travel required defining each track segment as an end of travel and managing a transition between two different tracks. A single motion command caused the mover to travel to the end of travel of one track segment, for example, in a positive direction. A transition motion command was required to manage transitioning the mover off the first track and on to the second track, despite these being adjacent track segments. A new motion command was then issued to command the mover to travel along the new track segment in the negative direction. Thus, three separate motion commands were required to manage a transition between two adjacent track segments, where the positive and negative directions were defined in opposite orientations, adding additional complexity for controlling motion of a mover along a continuous path of travel.

Thus, it would be desirable to provide an improved system and method for managing motion of vehicles at nodes in the independent cart system where two nodes having opposite directions of travel meet.

### BRIEF DESCRIPTION

According to a first embodiment of the invention, a method for node management in an independent cart system receives a path command at a controller for the independent cart system. The path command defines a desired motion for a mover in the independent cart system, and the path command spans at least one transfer segment and multiple fixed track segments for the independent cart system. Each of the fixed track segments has a predefined flow, and the at least one transfer segment has a dynamic flow. A single direction of travel is defined within the controller corresponding to the desired motion for the mover. A motion command, corresponding to the desired motion for the mover, is transmitted to each of the plurality of fixed track segments. The dynamic flow for the at least one transfer segment is set to the single direction, and a motion command is transmitted to the at least one transfer segment as a function of the dynamic flow for the at least one transfer segment and of the desired motion for the mover.

According to another embodiment of the invention, a method for node management in an independent cart system includes defining a direction of travel along multiple fixed track segments in the independent cart system, where the direction of travel is positive from a first end to a second end of each fixed track segment and the direction of travel is negative from the second end to the first end of each fixed track segment. A transfer segment is selectively positioned between a first pair of fixed track segments and a second pair of fixed track segments. The transfer segment has a predefined direction of travel as positive from a first end to a second end of the transfer segment and a predefined direction of travel as negative from the second end to the first end. When the transfer segment is positioned between the first pair of fixed track segments, the second end of a first fixed track segment, selected from the first pair of fixed track segments, aligns with the first end of the transfer segment and a first end of a second fixed track segment, selected from the first pair of fixed track segments, aligns with the second end of the transfer segment. When the transfer segment is positioned between the second pair of fixed track segments, the first end of a first fixed track segment, selected from the second pair of fixed track segments, aligns with the first end of the transfer segment and a second end of a second fixed track segment, selected from the second pair of fixed track segments, aligns with the second end of the transfer segment. A dynamic flow for the transfer segment is set as positive from the first end to the second end of the transfer segment when the transfer segment is positioned between the first pair of fixed track segments, and the dynamic flow for the transfer segment is set as positive from the second end to the first end of the transfer segment when the transfer segment is positioned between the first pair of fixed track segments.

According to still another embodiment of the invention, a system for node management in an independent cart system includes a mover, multiple track segments, and at least one transfer segment. The mover is operative to generate a magnetic field corresponding to a first portion of a linear drive system for the independent cart system. Each track segment includes a first end and a second end opposite the first end. A length of the track segment extends between the first end and the second end, and a positive direction of travel is defined along the length of the track segment between the first end and the second end. Each track segment also includes multiple coils positioned along the length of the track segment and a segment controller operative to regulate a current in each of the coils to generate an electromagnetic field corresponding to a second portion of the linear drive system. Each transfer segment includes a first end and a second end opposite the first end. A length of the at least one transfer segment extends between the first end and the second end, and a dynamic flow selectively defines a positive direction of travel in either direction between the first and second ends of the at least one transfer segment. Each transfer segment also includes multiple coils positioned along the length of the at least one transfer segment and a segment controller operative to regulate a current in each of the coils to generate an electromagnetic field corresponding to a second portion of the linear drive system. A controller is operative to receive a path command defining a desired motion for the mover, define a single direction of travel for the mover, generate a motion command for at least one track segment, selected from the multiple track segments, in the positive direction of travel, and set the dynamic flow for the at least one transfer segment such that the positive direction of travel is consistent with the positive direction for the at least one track segment.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 is a is a schematic representation of an exemplary control system for an independent cart system according to one embodiment of the invention;

FIG. 2 is a sectional view of one embodiment of a mover and track segment included in the linear drive system taken at 2-2 of FIG. 1;

FIG. 3 is a partial top cutaway view of the mover and track segment of FIG. 1;

FIG. 4 is a top plan view of a portion of a track layout for an independent cart system incorporating one embodiment of the invention;

FIG. 5 is a top plan view of the portion of the track layout of FIG. 4 identifying nodes;

FIG. 6 is an exemplary controller configuration for the portion of the track layout of FIG. 4 according to a first embodiment of the invention;

FIG. 7 is an exemplary controller configuration for the portion of the track layout of FIG. 4 according to a second embodiment of the invention;

FIG. 8 is a virtual path defined for each half of portion of the track layout of FIG. 4;

FIG. 9 is an exemplary look up table defining direction flows for the portion of the track layout of FIG. 4 according to a second embodiment of the invention; and

FIG. 10 is a top plan view of a portion of a track layout for another independent cart system incorporating one embodiment of the invention.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION

The various features and advantageous details of the subject matter disclosed herein are explained more fully with reference to the non-limiting embodiments described in detail in the following description.

The subject matter disclosed herein describes an improved system and method for managing motion of vehicles at nodes in the independent cart system where two track segments having opposite directions of travel meet. Segment controllers in each track segment coordinate motion between the two track segments as a mover transitions between adjacent track segments. Each segment controller regulates current in coils for the corresponding track segment to generate an electromagnetic field. The electromagnetic field interacts with a magnetic field generated by permanent magnets mounted on the mover to control operation of the mover. Each track segment has a predefined direction of motion along the track segment, and the corresponding segment controller regulates current according to the predefined motion to control operation of the mover. When adjacent track segments have opposite directions of travel, the segment controllers would fight each other during a transition if they attempted to regulate current in an identical manner. In order to manage transitions between adjacent track segments with opposite directions of travel, the adjacent ends of the track segments are defined as nodes. Either a node controller or one of the segment controllers are configured to manage communications between nodes. Data transmitted between nodes is translated from one direction to the other such that adjacent nodes on track segments with opposite directions of travel cooperate when transitioning a mover between the nodes.

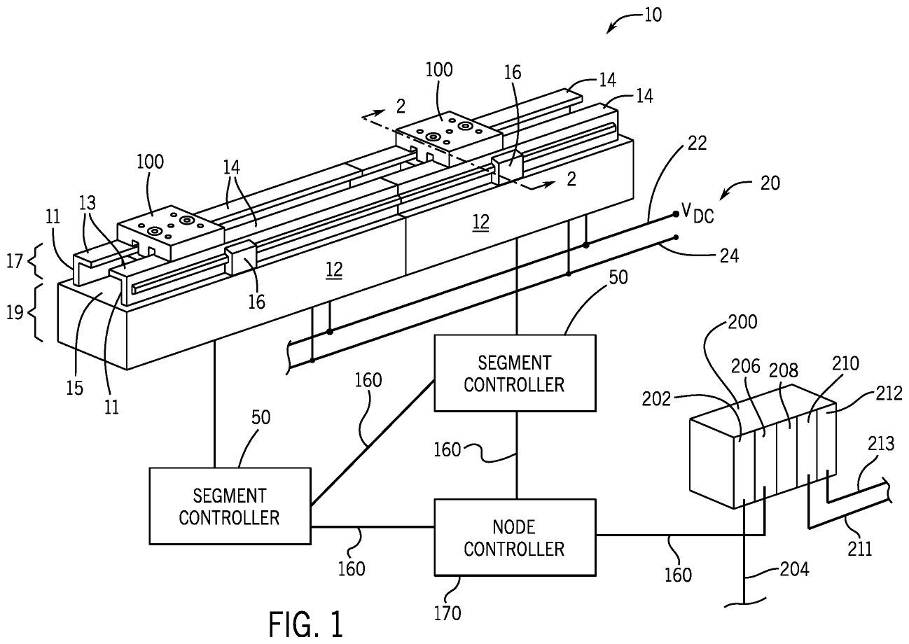

Turning initially to FIG. 1, an exemplary transport system for moving articles or products includes a track 10 made up of multiple segments 12. According to the illustrated embodiment, multiple segments 12 are joined end-to-end to define the overall track configuration. The illustrated segments 12 are both straight segments having generally the same length. It is understood that track segments of various sizes, lengths, and shapes may be connected together to form the track 10 without deviating from the scope of the invention. The track 10 is illustrated in a horizontal plane. For convenience, the horizontal orientation of the track 10 shown in FIG. 1 will be discussed herein. Terms such as upper, lower, inner, and outer will be used with respect to the illustrated track orientation. These terms are relational with respect to the illustrated track and are not intended to be limiting. It is understood that the track may be installed in different orientations, such as sloped or vertical, and include different shaped segments including, but not limited to, straight segments, inward bends, outward bends, up slopes, down slopes, right-hand switches, left-hand switches, and various combinations thereof. The width of the track 10 may be greater in either the horizontal or vertical direction according to application requirements. The movers 100 will travel along the track and take various orientations according to the configuration of the track 10 and the relationships discussed herein may vary accordingly.

According to the illustrated embodiment, the track receives power from a distributed DC voltage. A DC bus 20 receives a DC voltage, VDC, from a DC supply and conducts the DC voltage to each track segment 12. The illustrated DC bus 20 includes two voltage rails 22, 24 across which the DC voltage is present. The DC supply may include, for example, a rectifier front end configured to receive a single or multi-phase AC voltage at an input and to convert the AC voltage to the DC voltage. It is contemplated that the rectifier section may be passive, including a diode bridge or, active, including, for example, transistors, thyristors, silicon-controlled rectifiers, or other controlled solid-state devices. Although illustrated external to the track segment 12, it is contemplated that the DC bus 20 would extend within the lower portion 19 of the track segment. Each track segment 12 includes connectors to which either the DC supply or another track segment may be connected such that the DC bus 20 may extend for the length of the track 10. Optionally, each track segment 12 may be configured to include a rectifier section (not shown) and receive an AC voltage input. The rectifier section in each track segment 12 may convert the AC voltage to a DC voltage utilized by the corresponding track segment.

Each track segment 12 includes an upper portion 17 and a lower portion 19. The upper portion 17 is configured to carry the movers 100 and the lower portion 19 is configured to house the control elements. As illustrated, the upper portion 17 includes a pair of rails 14 extending longitudinally along the upper portion 17 of each track segment 12 and defining a channel 15 between the two rails. Clamps 16 affix to the sides of the rails 14 and secure the rails 14 to the lower portion 19 of the track segment 12. Each rail 14 is generally L-shaped with a side segment 11 extending in a generally orthogonal direction upward from the lower portion 19 of the track segment 12, and a top segment 13 extending inward toward the opposite rail 14. The top segment 13 extends generally parallel to the lower portion 19 of the track segment 12 and generally orthogonal to the side segment 11 of the rail 14. Each top segment 13 extends toward the opposite rail 14 for only a portion of the distance between rails 14, leaving a gap between the two rails 14. The gap and the channel 15 between rails 14 define a guideway along which the movers 100 travel.

According to one embodiment, the surfaces of the rails 14 and of the channel 15 are planar surfaces made of a low friction material along which movers 100 may slide. The contacting surfaces of the movers 100 may also be planar and made of a low friction material. It is contemplated that the surface may be, for example, nylon, Teflon®, aluminum, stainless steel and the like. Optionally, the hardness of the surfaces on the track segment 12 are greater than the contacting surface of the movers 100 such that the contacting surfaces of the movers 100 wear faster than the surface of the track segment 12. It is further contemplated that the contacting surfaces of the movers 100 may be removably mounted to the mover 100 such that they may be replaced if the wear exceeds a predefined amount. According to still other embodiments, the movers 100 may include low-friction rollers to engage the surfaces of the track segment 12. Optionally, the surfaces of the channel 15 may include different cross-sectional forms with the mover 100 including complementary sectional forms. Various other combinations of shapes and construction of the track segment 12 and mover 100 may be utilized without deviating from the scope of the invention.

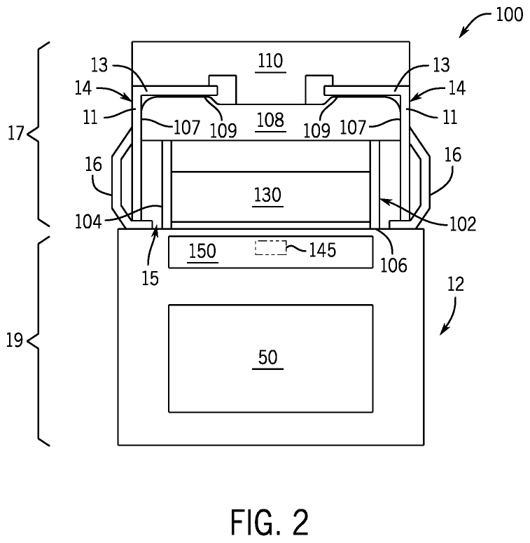

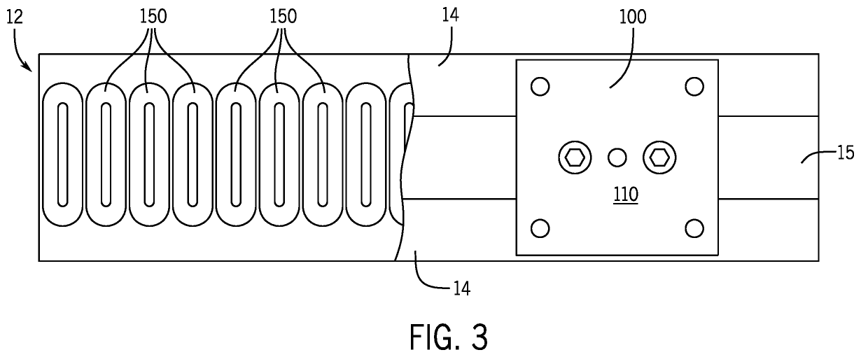

The mover 100 is carried along the track 10 by a linear drive system. The linear drive system is incorporated in part on each mover 100 and in part within each track segment 12. A first portion of the linear drive system includes one or more drive magnets 130 mounted to each mover 100. With reference to FIG. 2, the drive magnets 130 are arranged in a block on the lower surface of each mover. The linear drive system further includes a series of coils 150 spaced along the length of the track segment 12. With reference also to FIG. 3, the coils 150 may be positioned within a housing for the lower portion 19 of the track segment 12 and below the surface of the channel 15. The coils 150 are energized sequentially according to the configuration of the drive magnets 130 present on the movers 100. The sequential energization of the coils 150 generates a moving electromagnetic field that interacts with the magnetic field of the drive magnets 130 to propel each mover 100 along the track segment 12.

A segment controller 50 is provided within each track segment 12 to control the linear drive system and to achieve the desired motion of each mover 100 along the track segment 12. The segment controller 50 for each track segment 12 regulates current in the coils 150 to generate an electromagnetic field. Further, the segment controller 50 selectively energizes coils 150 along a length of the track segment 12 to create a moving electromagnetic field. This moving electromagnetic field interacts with the magnetic field generated by the drive magnets 130 on each mover 100 to cause the movers 100 to travel along the track segment. Regulating the current such that the electromagnetic field moves along the track segment 12 in a first direction causes the mover 100 to travel in the first direction, and regulating the current such that the electromagnetic field moves along the track segment 12 in the opposite direction causes the mover 100 to travel in the opposite direction.

Although illustrated in FIG. 1 as blocks external to the track segments 12, the arrangement is to facilitate illustration of interconnects between controllers. As shown in FIG. 2, it is contemplated that each segment controller 50 may be mounted in the lower portion 19 of the track segment 12. Each segment controller 50 is in communication with a node controller 170 which is, in turn, in communication with an industrial controller 200. The industrial controller may be, for example, a programmable logic controller (PLC) configured to control elements of a process line stationed along the track 10. The process line may be configured, for example, to fill and label boxes, bottles, or other containers loaded onto or held by the movers 100 as they travel along the line. In other embodiments, robotic assembly stations may perform various assembly and/or machining tasks on workpieces carried along by the movers 100. The exemplary industrial controller 200 includes: a power supply 202 with a power cable 204 connected, for example, to a utility power supply; a communication module 206 connected by a network medium 160 to the node controller 170; a processor module 208; an input module 210 receiving input signals 211 from sensors or other devices along the process line; and an output module 212 transmitting control signals 213 to controlled devices, actuators, and the like along the process line. The processor module 208 may identify when a mover 100 is required at a particular location and may monitor sensors, such as proximity sensors, position switches, or the like to verify that the mover 100 is at a desired location. The processor module 208 transmits the desired locations of each mover 100 to a node controller 170 where the node controller 170 operates to generate commands for each segment controller 50.

A position feedback system provides knowledge of the location of each mover 100 along the length of the track segment 12 to the segment controller 50. According to one embodiment of the invention, the position feedback system includes one or more position magnets mounted to the mover 100. According to another embodiment of the invention, the position feedback system utilizes the drive magnets 130 as position magnets. Position sensors 145 are positioned along the track segment 12 at a location suitable to detect the magnetic field generated by the drive magnets 130. According to the illustrated embodiment, the position sensors 145 are located below or interspersed with the coils 150. The sensors 145 are positioned such that each of the drive magnets 130 are proximate to the sensor as the mover 100 passes each sensor 145. The sensors 145 are a suitable magnetic field detector including, for example, a Hall Effect sensor, a magneto-diode, an anisotropic magnetoresistive (AMR) device, a giant magnetoresistive (GMR) device, a tunnel magnetoresistance (TMR) device, fluxgate sensor, or other microelectromechanical (MEMS) device configured to generate an electrical signal corresponding to the presence of a magnetic field. The magnetic field sensor 145 outputs a feedback signal provided to the segment controller 50 for the corresponding track segment 12 on which the sensor 145 is mounted. The position sensors 145 are spaced apart along the length of the track. According to one aspect of the invention, the position sensors 145 are spaced apart such that adjacent position sensors 145 generate a feedback signal which is offset from each other by ninety electrical degrees) (90°. Multiple position sensors 145 are, therefore, generating feedback signals in tandem for a single mover 100 as the mover is travelling along the track 10.

Each controller (i.e., the segment controller 50, the node controller 170, and the programmable logic controller 200) includes at least one processor and non-transitory memory. The non-transitory memory stores instructions for execution by the processor within the controller. It is contemplated that the processor and non-transitory memory may each be a single electronic device or formed from multiple devices. The processor may be a microprocessor. Optionally, the processor and/or the non-transitory memory may be integrated on a field programmable gate array (FPGA) or an application specific integrated circuit (ASIC). The instructions include one or modules, control programs, and/or an operating system to achieve the desired functions of the corresponding controller. Although certain features of the present invention are discussed herein as being performed by specific controllers, in alternate embodiments, some features may be performed by another controller within the system.

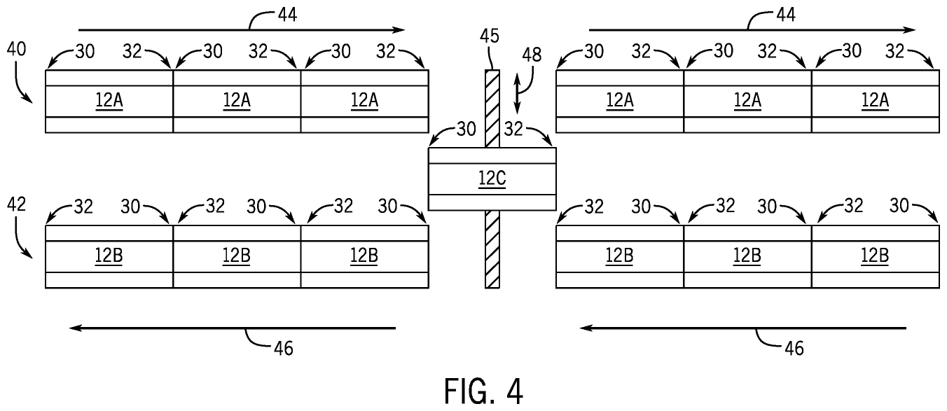

Turning next to FIG. 4, an independent cart system may include multiple tracks with a transfer segment configured to move between the tracks. According to the illustrated embodiment, a first track 40 is configured to have a first direction of travel 44 for movers 100 travelling along the first track. A second track 42 is configured to have a second direction of travel 46 for movers travelling along the second track. The first track 40 and the second track 42 are each made up of multiple track segments 12. As illustrated, the first track 40 includes multiple first track segments 12A, and the second track 42 includes multiple second track segments 12B. As used herein, an element referred to by a reference numeral without a letter describes the element generally. An element referred to by a reference numeral with a following letter refers to a particular instance of the element. For example, discussion of track segments 12 above refer to track segments generally. Discussion of first track segments 12A and second track segments 12B identify the track segments associated with the first track 40 and with the second track 42, respectively. A third track segment 12C is mounted on translation member 45 such that it is selectively positioned between the first track 40 and the second track 42. A mover 100 may be driven onto the third track segment 12C from the first track 40 when the third track segment 12C is aligned with the first track segments 12A, or the mover 100 may be drive onto the third track segment 12C from the second track 42 when the third track segment is aligned with the second track segments 12B. A mover 100 may leave the third track segment 12C along the same track 40, 42 from which the mover entered the third track segment 12C or, the mover 100 may remain on the third track segment 12C as the third track segment is moved between the two tracks 40, 42 by the translation member 45 and then the mover 100 may leave the third track segment 12C along a different track 40, 42 than the track from which the mover entered the third track segment 12C. Although illustrated with just two tracks 40, 42 and a single transfer segment 12C, the independent cart system may have more than two tracks and may include multiple transfer segments to selectively move between the different tracks. Further, the translation member 45 may be configured for lateral movement (as illustrated), rotary movement, or vertical movement to raise or lower the transfer segment between different tracks according to an application's requirements.

In operation, each track segment 12 has a predefined direction of travel, also referred to herein as a predefined flow. Travel in a positive direction extends from a first end 30 of the track segment 12 to a second end 32 of the track segment. Similarly, travel in a negative direction extends from the second end 32 of the track segment to the first end 30 of the track segment. The definition of positive and negative directions of travel are used by the segment controller 50 to regulate current in the coils 150 in the corresponding track segment 12 to control operation of a mover 100 present on the track segment in the desired direction of travel.

As discussed above, each track segment 12 includes a linear drive system, where sequential energization of the coils 150 generates a moving electromagnetic field that interacts with the magnetic field of the drive magnets 130 to propel each mover 100 along the track segment 12. The segment controllers 50 regulate current in a positive direction to cause the mover 100 to travel in the positive direction along the track segment 12, and the segment controllers 50 regulate current in a negative direction to cause the mover 100 to travel in the negative direction along the track segment 12. The position sensors 145 generate feedback signals corresponding to the strength of the magnetic field generated by the drive magnets 130 present on each mover. The segment controllers 50 maintain a table defining locations of each position sensor 145 and of the construction of each mover 100, such that the segment controllers 50 are able to convert the feedback signal from the position sensors 145 to a present location of each mover 100 along the track segment 12. One or more reference points are defined along the track as a reference position having a predefined position value. The position values along each track segment 12 then increase along each track segment 12 with respect to one of the reference positions as the mover 100 travels in the positive direction and decrease as the mover travels in the negative direction.

Segment controllers 50 in adjacent track segments 12 are in communication with each other to coordinate transition of movers 100 from one track segment 12 to the next track segment. According to one aspect of the invention, the segment controller 50 for the track segment 12 on which the mover 100 is initially located is responsible for controlling operation of the mover 100 over a first portion of the transition, and the segment controller 50 for the track segment 12 on which the mover 100 is finally located is responsible for controlling operation of the mover 100 over a second portion of the transition. During the first portion of the transition, the first segment controller 50 may generate current, speed, and/or position reference signals for regulating current in the coils 150 on both the first and the second track segments 12 in order to synchronize motion of the mover 100 between the two track segments. During the second portion of the transition, the second segment controller 50 may generate current, speed, and/or position reference signals for regulating current in the coils 150 on both the first and the second track segments in order to continue coordinated motion of the mover 100 between the two track segments 12. Each segment controller 50 will generate the reference signals according to a flow defined on the corresponding track segment in which the segment controller 50 is located.

When adjacent segment controllers 50 are coordinating motion between the two corresponding track segments 12, continuity in flow between the adjacent track segments is important. For track segments 12 with predefined flows in the same direction, the continuity is readily accomplished. A segment controller 50 initially controlling a mover 100 present on the corresponding track segment may pass current, position, and/or speed reference and/or feedback values to the segment controller 50 in the adjacent track segment and the adjacent track segment utilizes those reference and/or feedback values to coordinate control on the adjacent track segment 12 as the mover 100 transitions between the two track segments. However, when track segments 12 with predefined flows in opposite directions are aligned next to each other, a positive current or speed reference in one track segment 12 corresponds to motion in one direction. The same positive current or speed reference in the adjacent track segment 12 corresponds to motion in the other direction. Sharing such a reference signal or the corresponding feedback signal between segment controllers 50 would result in the two adjacent segment controllers 50 attempting to command the mover 100 to travel in opposite directions.

In order to provide a smooth transition between adjacent track segments 12, the segment controllers must coordinate motion between the two track segments. A segment controller 50 on one track segment 12 regulates current to the coils 150 on that track segment. However, as a mover 100 transitions between track segments 12, it is, for a time, partially located on each track segment and both segment controllers 50 regulate current to a portion of the coils 150 responsible for motion of the mover 100. It is desirable to maintain current waveforms that have the same amplitude and are coordinated in phase between adjacent track segments 12. Consistent current waveforms result in consistent electromagnetic fields generated by each track segment to smoothly control operation of the mover 100. It is also desirable to maintain consistent position measurements between track segments 12. If one track segment 12 receives a feedback signal indicating the mover 100 is at a first position and the adjacent track segment 12 receives a feedback signal indicating the mover 100 is at a second position (even if the two positions are just millimeters apart), the two controllers 50 will each attempt to regulate motion of the mover 100 to match the commanded position. Without coordination of the current, position, and/or speed references and feedback signals during a transition between adjacent segment controllers 50, the mover 100 may experience step changes in operation, which are often observed as “bumps” in operation, vibration as the two segment controllers 50 temporarily oppose each other, or other undesirable performance during a transition between adjacent track segments 12 and control by adjacent segment controllers 50.

The independent cart system disclosed herein provides an improved system and method for managing motion of mover 100 as they transition between track segments 12 having opposing predefined flows. A segment controller 50, node controller 170, industrial controller 200 or a combination thereof is configured to manage flow between track segments 12 with opposing predefined flows. A transfer segment may be defined between track segments 12 with opposing predefined flows. Although the transfer segment itself includes a predefined flow, the transfer segment also includes a dynamic flow. The dynamic flow may be selectively configured for positive and negative directions of travel between either end of the transfer segment. The dynamic flow is configured to provide a continuous flow between adjacent track segments regardless of their respective predefined flows.

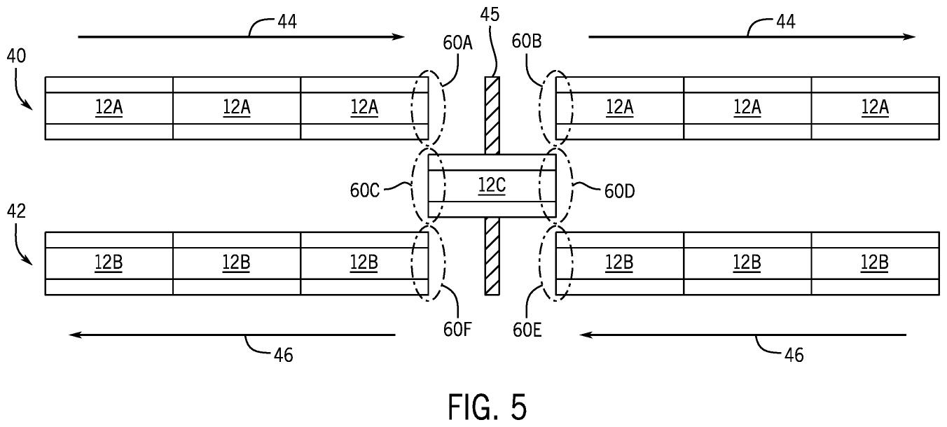

With reference to FIGS. 4 and 5, an exemplary track layout with two tracks 40, 42 and a transfer segment 12C selectively positioned between the two tracks is illustrated. The first track 40 has a first direction of travel 44 defined from left-to-right in the figure for movers 100 travelling along the first track, and the second track 42 has a second direction of travel 46 defined from right-to-left for movers travelling along the second track. Both the first track 40 and the second track 40 are each made up of multiple track segments 12. Each of the track segments includes a first end 30 and a second end 32. Each fixed track segment 12A in the first track 40 has a first end 30 oriented toward the left side of the figure and a second end 32 oriented toward the right side of the figure. The first end 30 of one fixed track segment 12A in the first track 40 is aligned next to the second end 32 of the adjacent fixed track segment 12A in the first track 40. Each fixed track segment 12B in the second track 42 has a first end 30 oriented toward the right side of the figure and a second end 32 oriented toward the left side of the figure. The first end 30 of one fixed track segment 12B in the second track 42 is aligned next to the second end 32 of the adjacent fixed track segment 12B in the second track 42. The transfer segment 12C is mounted on a translation member 45. As indicated by direction arrow 48, the transfer segment 12C is selectively positioned between the first and second tracks 40, 42. The transfer segment 12C may allow for a track configuration in which optional processing steps are performed on a payload present on a mover 100. The optional processing steps may be performed along a loop formed, in part, by the fixed track segments 12A, 12B to the right of the translation member 45. If a mover 100 is carrying a payload which does not require the optional processing steps, it may transition from the first track 40 to the second track 42 via the transfer segment 12C, avoiding unnecessary travel along a portion of the track. As noted in FIGS. 4 and 5, the transfer segment 12C includes a predefined flow across the transfer segment 12C from left-to-right. The first end 30 of the transfer segment 12C is oriented toward the left side of the figure, and the second end 32 of the transfer segment 12C is oriented toward the right side of the figure. Thus, when the transfer segment 12C is present within the first track 40, the predefined flow for the transfer segment 12C is consistent with the predefined flow for the fixed track segment 12A in the first path. However, when the transfer segment 12C is moved into the second track 42, the predefined flow for the transfer segment 12C is opposite the predefined flow for the fixed track segments 12B in the second path. A dynamic flow will be assigned to the transfer segment to coordinate motion between fixed track segments 12B in the second track 42 and the transfer segment 12C.

With reference to FIG. 5, nodes 60 are defined along the independent cart system at any location where potential exists for the predefined flow between adjacent track segments 12 to oppose each other. This potential exists at any junction between a transfer segment 12C and a fixed segment 12A or 12B. According to the illustrated system, a first node 60A is assigned at the end of the first portion of the first track 40, and a second node 60B is assigned at the start of the second portion of the first track 40. A third node 60C is assigned at the first end 30 of the transfer segment 12C, and a fourth node 60D is assigned at the second end 32 of the transfer segment 12C. A fifth node 60E is assigned at the end of the first portion of the second track 42, and a sixth node 60F is assigned at the start of the second portion of the second track 42.

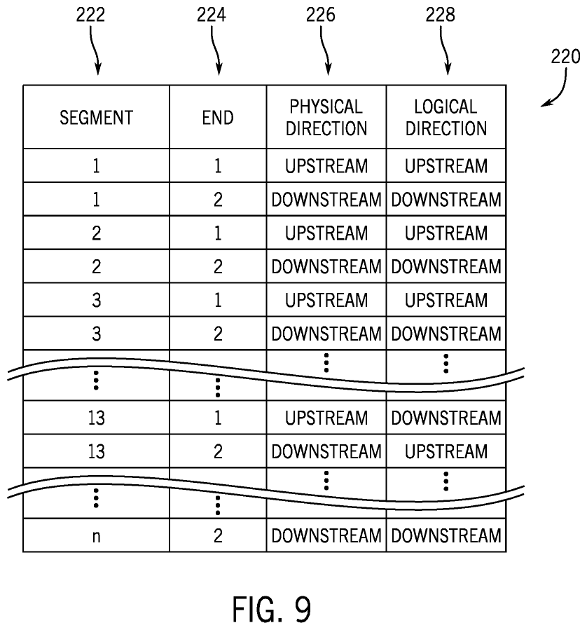

With reference to FIG. 9, a look up table 220 may be provided which stores a predefined flow and a dynamic flow for each track segment. According to one aspect of the invention, the look up table 220 may include entries only for those track segments 12 on which a node 60 is defined. Optionally, the look up table 220 may include entries for every track segment 12 in the independent cart system. The illustrated look up table 220 includes entries for each track segment 12. A first column 222 in the look up table defines the track segment 12 being described. A second column 224 in the look up table defines a particular end of the track segment. The third column 226 provides the predefined flow, or physical direction, for the corresponding track segment 12. A positive direction, for example, extends from an upstream end toward a downstream end. Thus, identifying each end, or at least one end, of the track segment 12 as either upstream or downstream indicates the predefined flow for the corresponding track segment. The fourth column provides the dynamic flow, or logical direction, for the corresponding track segment 12. Again, a positive direction extends from an upstream end toward a downstream end. Identifying each end, or at least one end, of the track segment 12 as either upstream or downstream indicates the dynamic flow for the corresponding track segment. As shown with respect to the switch track segment, identified as track segment number 13, the dynamic flow, or logical direction, does not need to match the predefined flow, or physical direction.

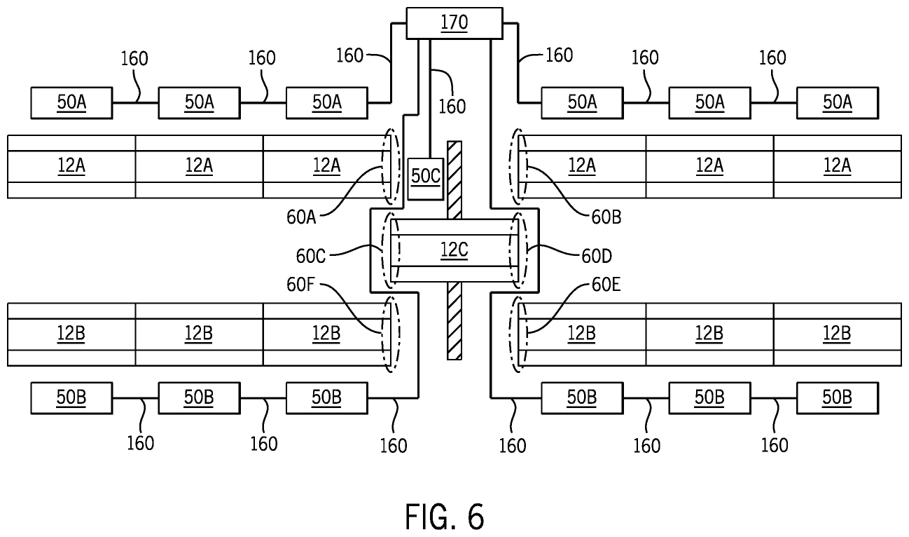

Turning next to FIG. 6, a node controller 170 is provided to manage data flow between segment controllers 50 in each track segment for which a node 60 is defined. The look up table 220 is stored in memory of the node controller 170. Network media 160 extends between the node controller 170 and each segment controller 50 for one of the track segments 12 on which a node 60 is defined. Data passed between segment controllers 50 and used to control motion of a mover 100 is first read by the node controller 170. The node controller 170 also reads the dynamic flow and/or the predefined flow for each track or transfer segment 12 to determine whether the directions of travel along each track segment match. If the directions of travel match, the node controller 170 may simply pass through the data received from one segment controller 50 to the other segment controller. The two segment controllers 50 may control operation of the mover 100 as it transitions between the two track segments without intervention by the node controller 170. If, however, the directions of travel for the two segments do not match, the node controller 170 intervenes to translate data transferred between the two track segments according to the dynamic flow for each track segment. If, for example, a speed reference or speed feedback signal is transferred between the two segment controllers, the node controller 170 may invert the values of the speed reference and/or speed feedback prior to passing the data packet along. Therefore, if a segment controller 50 on the first track segment 12 is commanding the mover 100 to travel in a positive direction, the segment controller 50 on the track segment for which the predefined direction is reversed receives a speed reference and/or a speed feedback indicating the mover 100 is commanded to and is travelling in a negative direction. This negative direction corresponds to the predefined direction on the second track segment 12, and the segment controller 50 on the second track segment can coordinate operation of the mover 100 with the segment controller 50 on the first track segment as the mover 100 transitions between the two track segments. Similarly, if a current reference and/or a current feedback signal is transferred between the two segment controllers, the node controller 170 may translate the current reference and/or current feedback signal to a corresponding current reference and/or current feedback signal for travelling in the reverse direction. If a position reference and/or position feedback signal is being transferred between segment controllers, the first segment controller 50 may have a coordinate system for position counting up with a positive direction predefined between the first end and the second end of the corresponding track segment 12. The second segment controller 50, however, may also have a coordinate system for position counting up with a positive direction predefined between the first end and the second end of the corresponding track segment 12. If the second ends of the two track segments are adjacent to each other, the two segment controllers will have differing position information at which they are attempting to regulate operation of the mover. The node controller 170 may instead translate the position reference and/or position feedback information being transmitted from the first segment controller 50 to the coordinate system defined on the second segment controller 50. Thus, the second segment controller 50 receives a position reference signal and/or a position feedback signal from the first segment controller 50 that corresponds to the coordinate system defined on the second segment controller.

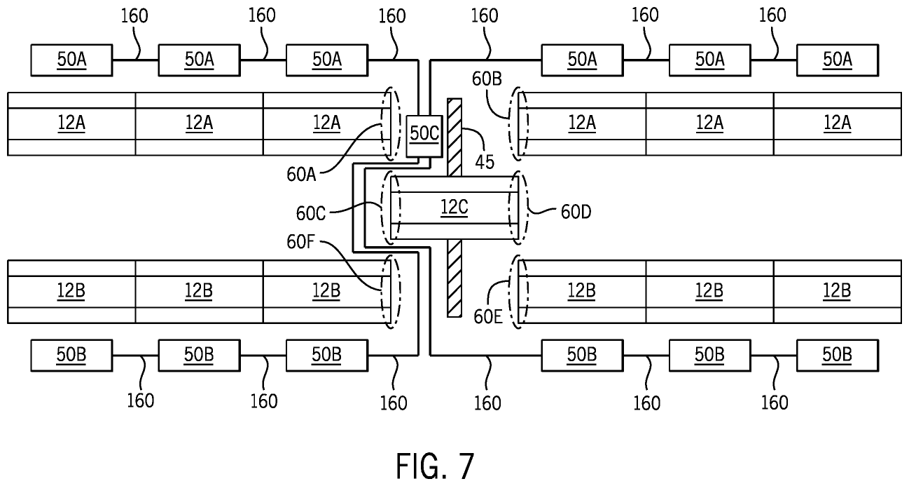

With reference next to FIG. 7, the description of the operation of the node controller 170 above, may be implemented in one of the segment controllers 50. According to the illustrated embodiment. The segment controller 50C in the transfer segment manages the data flow between each of the segment controllers 50A, 50B for the fixed track segments 12A, 12B which may be adjacent to the transfer segment 12C. The look up table 220 is stored in memory of the segment controller 50C on the transfer segment 12C. Network media 160 extends between each segment controller 50. The segment controller 50C on the transfer segment 12C reads the dynamic flow for each track or transfer segment 12 to determine whether the directions of travel along each track segment match and performs and necessary modification of the data being transmitted according to the direction of travel for each track segment.

According to another aspect of the invention, virtual paths may be used to define desired travel of movers 100 within the independent cart system. A virtual path provides a simplified method of programming desired paths. Each virtual path 70, 72 may be used to define a sequential order of track segments 12 across which the mover 100 travels. Each track segment 12 has an identifier corresponding to the track segment. According to the illustrated embodiment, the track segments in the first track 40 are labelled from one to six. The track segments in the second track 42 are labelled from seven to twelve. The transfer segment is labelled as track segment number thirteen. These identifiers may be used in the look up table to identify each track segment. With respect to the look up table in FIG. 9, the identifier for each track segment is used in the first column 222 of the look up table to identify the corresponding track segments. The first virtual path 70 defines a sequence of track segments 12 defined from the letter “A” to the letter “G” that correspond to a portion of the fixed track segments and the transfer segment. The second virtual path 72 defines a sequence of track segments 12 defined from the letter “H” to the letter “N” that correspond to a portion of the fixed track segments and the transfer segment. Any sequence of identifiers may be used to identify track segments along a path. Further, if the sixth and seventh track segments were curved and joined the first track 40 to the second track 42, the two virtual paths 70, 72 may correspond to a single virtual path defining a loop along both tracks.

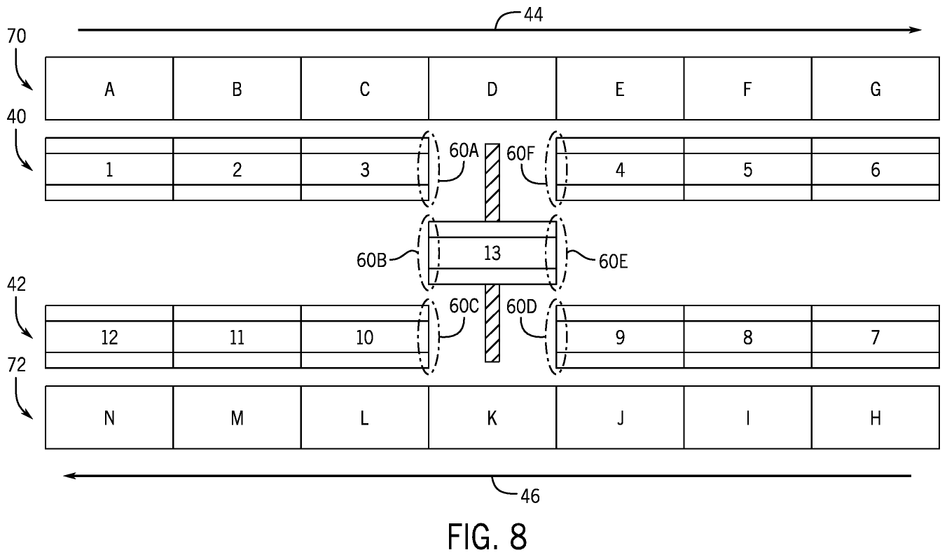

The virtual paths are defined by a user and may be utilized, for example, in a control program executing in the industrial controller 200 to conveniently identify desired paths of travel for a mover 100 or a series of movers. The control program monitors operation of a machine, process, or other application executing in tandem with the independent cart system. When the control program detects a need for one or more movers 100 to service the machine, a station in the process, or another aspect of the application, the control program generates a path command for the mover 100. The path command defines a desired motion for the mover, which may be, for example, travelling along the track segments for the first virtual path 70. Each of the fixed track segments 12A in the first track 40 has a predefined flow consistent with the direction of the first virtual path 70. When the transfer segment 12C (identified as track segment number 13 in FIG. 8), is located between fixed track segments 12A in the first path, the predefined flow for the transfer segment 12C is also consistent with the direction of the first virtual path 70. The dynamic flow for the transfer segment 12C is set in the same direction as its predefined flow such that all track segments along the first virtual path 70 will receive a motion command in the direction of the first virtual path 70. Either the node controller 170 or one of the segment controllers 50 managing the dynamic flow establishes the flow direction for each track segment.

The industrial controller 200 may transmit the virtual path command to the node controller or, alternately, the industrial controller 200 may first convert the virtual path command to a path command corresponding to track segments between which a mover 100 is to travel. The node controller 170 receives the path command and passes the motion command to each track segment 12. According to one aspect of the invention, a motion command may follow a mover 100 along a distributed control system. For the first virtual path 70, the motion command may initially be transmitted to the segment controller 50 for the first track segment, identified by the letter “A” in the virtual path or as track segment number one by track segment identifiers. As the mover 100 travels along the path, each segment controller 50 passes the motion command to the segment controller 50 in the next adjacent track or transfer segment. Alternately, the node controller 170 may transmit a motion command to the segment controllers 50 for each of the track and transfer segments along the path and each segment controller 50 manages control of the mover 100 when the mover reaches the corresponding track or transfer segment.

With reference again to the first virtual path 70, the first virtual path 70 is commanded to travel in the positive direction 44 of the first track 40. The motion command sent to each fixed track segment 12A corresponds to the predefined flow associated with each track segment 12A in the first track 40, and each segment controller 50 controls the mover 100 accordingly as the mover 100 reaches the corresponding track segment 12A. The dynamic flow for the transfer segment 12C is set such that the positive direction is consistent with the positive direction 44 of the first track 40, and the motion command sent to the segment controller 50 for the transfer segment corresponds to the direction set in the dynamic flow.

Similarly, the second virtual path 72 is commanded to travel in the positive direction 46 of the second track 42. The motion command sent to each fixed track segment 12B corresponds to the predefined flow associated with each track segment 12B in the second track 42, and each segment controller 50 controls the mover 100 accordingly as the mover 100 reaches the corresponding track segment 12B. The dynamic flow for the transfer segment 12C is set such that the positive direction is consistent with the positive direction 46 of the second track 42, and the motion command sent to the segment controller 50 for the transfer segment corresponds to the direction set in the dynamic flow.

As seen from the description of the two virtual paths 70, 72, a user simply defines a desired path for a mover 100 between two end points with a consistent direction between those two end points without worrying about nodes 60 adjacent to each other with opposite predefined flow directions. The dynamic flow for the transfer segment 12C compensates for opposing directions of travel defined for the track segment. While the predefined flow of the transfer segment 12C is in the same direction as the track segments 12A in the first track 40, when the transfer segment 12C moves to the second track 42, opposing predefined flows occur on both ends of the transfer segment 12C with the adjacent track segments 12B in the second track 42. However, the dynamic flow is set consistent with the desired direction of travel for the virtual path 72. The node controller 170 uses the look up table 220 to identify a logical direction 228 which is opposite to the physical direction 226 and translates data transferred between the segment controllers 50 as a mover transitions between the track segment 12B in the second track 42 and the transfer segment 12C.

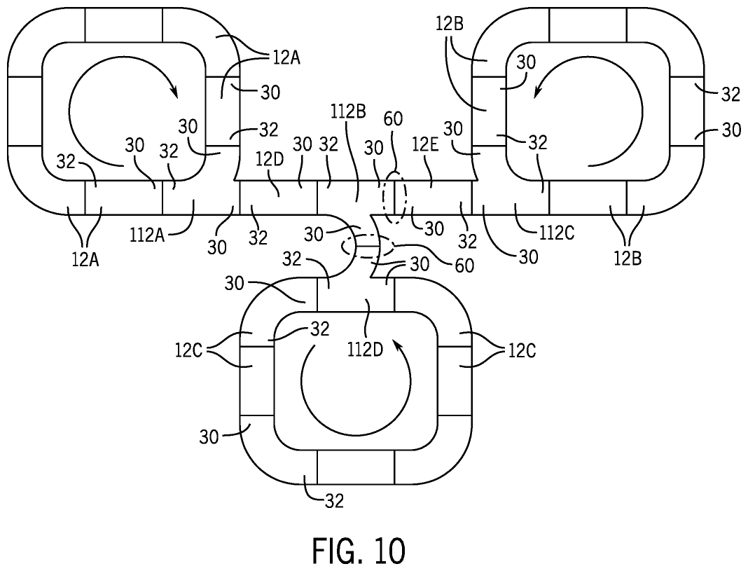

To this point, the dynamic flow has been described with respect to one application, namely a transfer segment 12C moving between two different tracks, where one track includes a predefined flow opposite of the transfer segment. With reference next to FIG. 10, another application of dynamic flow is illustrated where a transfer segment has a fixed relationship with adjacent track segments. FIG. 10 illustrates an independent cart system having three primary loops. Each loop may perform a different function, may act on different payloads, or in some other way require movers 100 to travel along the loop for different purposes. The industrial controller 200 monitors operation of the application and issues path commands when movers 100 are required at different locations. A portion of the movers 100 may simply remain within one of the loops, travelling repeatedly around the loop. Other movers 100 may be required to transition between two or all three of the loops. As noted in FIG. 10, each track segment is a fixed track segment. A first portion of the track segments 12 has a single path traversing the track segment or, in other words, the track segments 12 have a single input and/or output on each end of the track segment. A second portion of the track segments are switch track segments 112 having two paths on one end and a single path on the other end. The predefined flow along the switch track segments defines the first end 30 as the end with two paths and the second end 32 as the end with one path.

As observed in FIG. 10, it is not possible to arrange every track segment 12 and switch track segment 112 in a configuration such that the predefined flows across each segment are consistent with adjacent track segments. Each of the track segments 12A in the first loop as well as the first switch segment 112A are arranged such that the predefined flows of each segment around the first loop are in the same direction as an adjacent track segment. Similarly, each of the track segments 12B in the second loop as well as the third switch segment 112C are arranged such that the predefined flows of each segment around the second loop are in the same direction as an adjacent track segment. Each of the track segments 12C and one leg of the fourth switch segment 112D in the third loop are also arranged such that the predefined flows of each segment in the third loop are in the same direction as an adjacent track segment. However, as noted by the circled nodes 60, the junction of one path for the second switch segment 112B with one path of the fourth switch segment 112D has two first ends 30 adjacent to each other. Similarly, the other path of the second switch segment 112B is adjacent to a first end 30 of a connecting track segment 12E, where the connecting track segment 12E is positioned between the second switch segment 112B and the third switch segment 112C. Even with the relatively simple, three-loop configuration shown in FIG. 10, there are two nodes 60 identified where track segments 12 and/or switch track segments 112 are positioned adjacent to another track segment with opposing predefined flows. As track layouts for independent cart systems grow even more complex with additional loops and multiple paths, the number of nodes 60 where track segments are positioned adjacent to another track segment with opposing predefined flows will increase.

Although each of the track segments 12 and switch track segments 112 illustrated in FIG. 10 are fixed, a dynamic flow may be assigned to either a track segment 12 with a single path or to the switch track segment 112 having multiple paths in a manner similar to that discussed above with respect to the transfer segment 12C, which moved between tracks. A path command is generated corresponding to a desired motion for one or more of the movers 100 in the independent cart system. The path may include a virtual path defining a single direction of movement between a starting point and a desired ending point for the mover. According to one aspect of the invention, the look up table 220 may include entries for every track segment. The predefined direction and a dynamic direction may be set for every track segment. Optionally, only those track segments 12 including a node 60 where the end of the track segment is adjacent to another track segment having an opposing direction may be listed in the look up table 220.

If every track segment 12 and switch track segment 112 is included in the look up table 220, each segment controller 50 may be responsible for translating data transmitted between adjacent track segments as needed. Each segment controller 50 may either store a copy of the look up table 220 or have read access to a copy of the look up table 220 stored, for example, in a node controller 170 in communication with the segment controller 50. When the dynamic flow matches the predefined flow for the corresponding track segment, no translation of data is required. If, however, the dynamic flow is in the opposite direction of the predefined flow, the segment controller 50 translates data transferred between adjacent segment controllers 50 to the proper polarity and/or position reference frame for the track segment 12 on which the segment controller 50 executes to control operation of a mover 100.

Thus far, the dynamic flow has been discussed with respect to track segments positioned adjacent to each other with opposing predefined flows. According to another aspect of the invention, the dynamic flow may additionally facilitate bidirectional motion along the independent cart system. In many applications, it is desirable and even preferable to maintain operation of movers 100 in a single direction. A track having a single loop, for example, includes multiple movers 100 which repeatedly travel in the same direction around the loop. Steps in a process may be repeatedly performed on a payload present on each mover 100 along a first portion of the loop, and the movers 100 travel from an end of the process back to the start of the process along a second portion of the loop. Thus, the movers 100 along the loop continuously travel in one direction.

However, with reference again to FIG. 10, more complex track configurations may necessitate bidirectional travel of movers 100 along at least a portion of the track. The connecting segments including, for example, a first connecting track segment 12D, a second connecting track segment 12E, and the second switch track segments 112B in FIG. 10 facilitate travel of movers 100 between the different loops. Further, the first connecting track segment 12D and the second connecting track segment 12E are arranged along a straight portion of the track with opposing predefined directions. The opposing arrangement of the two connecting track segments 12D, 12E minimizes the overall number of nodes 60 in the system which are directly adjacent to each other and have opposing directions. However, any mover 100 travelling along the connection between the first and second loops will necessarily be travelling in an opposing direction to the predefined direction along at least one of the connecting track segments 12D, 12E. Thus, when a mover 100 travels from the first loop to the second loop, the dynamic flow for the first connecting track segment 12D is set with a positive direction opposing its predefined flow. The dynamic flow for the second connecting track segment 12E is also set in a positive direction from the first loop to the second loop. However, this positive direction is consistent with the positive direction of the predefined flow for the second connecting track segment 12E. Similarly, when a mover 100 travels from the second loop to the first loop, the dynamic flow for the second connecting track segment 12E is set with a positive direction opposing its predefined flow. The dynamic flow for the first connecting track segment 12D is also set in a positive direction from the second loop to the first loop. However, this positive direction is consistent with the positive direction of the predefined flow for the first connecting track segment 12D.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

We claim:

1. A method for node management in an independent cart system, the method comprising:
receiving a path command at a controller for the independent cart system, wherein:
the path command defines a desired motion for a mover in the independent cart system,
the path command spans at least one transfer segment and a plurality of fixed track segments for the independent cart system,
each of the plurality of fixed track segments has a predefined flow, and
the at least one transfer segment has a dynamic flow;
defining a single direction of travel within the controller corresponding to the desired motion for the mover;
transmitting a motion command corresponding to the desired motion for the mover to each of the plurality of fixed track segments;
setting the dynamic flow for the at least one transfer segment to the single direction; and
transmitting a motion command to the at least one transfer segment as a function of the dynamic flow for the at least one transfer segment and of the desired motion for the mover.

2. The method of claim 1, wherein:
the predefined flow for each of the plurality of fixed track segments sets a positive direction of travel from a first end to a second end of a corresponding fixed track segment and a negative direction of travel from the second end to the first end of the corresponding track segment;
the first end of one of the plurality of fixed track segments is positioned adjacent to either the second end of another of the plurality of fixed track segments or one end of the at least one transfer segment;
the second end of one of the plurality of fixed track segments is positioned adjacent to either the first end of another of the plurality of fixed track segments or one end of the at least one transfer segment; and
the dynamic flow for the at least one transfer segment selectively sets the positive direction and the negative direction of travel along the at least one transfer segment.

3. The method of claim 2, wherein the step of setting the dynamic flow for the at least one transfer segment to the single direction includes storing the single direction in a look up table, wherein the look up table includes a predefined flow for the transfer segment and the single direction selectively defines the dynamic flow for the transfer segment.

4. The method of claim 1, wherein the desired motion for the mover includes the steps of:
travelling from a first fixed track segment to a first transfer segment; and
travelling from the first transfer segment to a second fixed track segment, wherein:
the predefined flow for the first fixed track segment and the predefined flow for the second fixed track segment are both defined with the positive direction either toward the first transfer segment or away from the first transfer segment, and
the dynamic flow for the first transfer segment translates the path command between the opposing positive directions for the first and second fixed track segments as the mover travels across the first transfer segment.

5. The method of claim 1, further comprising the steps of:
regulating a current in each of the plurality of fixed track segments with a segment controller corresponding to the fixed track segment as the mover travels along the fixed track segment; and
regulating a current in either a first fixed track segment or a first transfer segment with the segment controller corresponding to either the first fixed track segment or the first transfer segment as the mover transitions between the first fixed track segment and the first transfer segment, wherein:
a predefined flow for the first transfer segment is in an opposite direction as the predefined flow for the first fixed track segment, and
the dynamic flow for the first transfer segment is in the same direction as the predefined flow for the first fixed track segment.

6. The method of claim 5, wherein the step of regulating the current in either the first fixed track segment or the first transfer segment with the segment controller corresponding to either the first fixed track segment or the first transfer segment as the mover transitions between the first fixed track and the first transfer segment further comprises the steps of:
regulating the current in either the first fixed track segment or the first transfer segment for a first portion of the mover transitioning according to which of the first fixed track segment or the first transfer segment the mover is initially located;
regulating the current in either the first fixed track segment or the first transfer segment for a second portion of the mover transitioning according to which of the first fixed track segment or the first transfer segment the mover is finally located;
transmitting at least one of a current reference, a current feedback, a velocity reference, or a velocity feedback between the segment controller for each of the first fixed track segment and the first transfer segment as the mover transitions between the first fixed track segment and the first transfer segment; and
inverting at least one of the current reference, the current feedback, the velocity reference, or the velocity feedback as it is transmitted between the segment controllers with the controller when the dynamic flow for the first transfer segment is in an opposite direction of the predefined flow for the first transfer segment.

7. The method of claim 5, wherein the controller is a node controller for the independent cart system.

8. The method of claim 5, wherein the controller is the segment controller for either the first fixed track segment or the first transfer segment.

9. A method for node management in an independent cart system, the method comprising:
defining a direction of travel along a plurality of fixed track segments in the independent cart system, wherein:
the direction of travel is positive from a first end to a second end of each fixed track segment, and
the direction of travel is negative from the second end to the first end of each fixed track segment;
selectively positioning a transfer segment between a first pair of fixed track segments and a second pair of fixed track segments, wherein:
the transfer segment has a predefined direction of travel as positive from a first end to a second end of the transfer segment and a predefined direction of travel as negative from the second end to the first end,
when the transfer segment is positioned between the first pair of fixed track segments, the second end of a first fixed track segment, selected from the first pair of fixed track segments, aligns with the first end of the transfer segment and a first end of a second fixed track segment, selected from the first pair of fixed track segments, aligns with the second end of the transfer segment, and
when the transfer segment is positioned between the second pair of fixed track segments, the first end of a first fixed track segment, selected from the second pair of fixed track segments, aligns with the first end of the transfer segment and a second end of a second fixed track segment, selected from the second pair of fixed track segments, aligns with the second end of the transfer segment;
setting a dynamic flow for the transfer segment as positive from the first end to the second end of the transfer segment when the transfer segment is positioned between the first pair of fixed track segments; and
setting the dynamic flow for the transfer segment as positive from the second end to the first end of the transfer segment when the transfer segment is positioned between the first pair of fixed track segments.

10. The method of claim 9, further comprising the steps of
controlling at least one mover to travel along each of the plurality of fixed track segments with a segment controller present on the corresponding fixed track segment as a function of the predefined direction; and
controlling the at least one mover to travel along the transfer segment with a segment controller present on the transfer segment as a function of the dynamic flow.

11. The method of claim 9, further comprising the steps of:
regulating a current in each of the plurality of fixed track segments with a segment controller corresponding to the fixed track segment as the mover travels along the fixed track segment; and
regulating a current in either a first fixed track segment or a first transfer segment with the segment controller corresponding to either the first fixed track segment or the first transfer segment as the mover transitions between the first fixed track segment and the first transfer segment, wherein:
a predefined flow for the first transfer segment is in an opposite direction as the predefined flow for the first fixed track segment, and
the dynamic flow for the first transfer segment is in the same direction as the predefined flow for the first fixed track segment.

12. The method of claim 11, wherein the step of regulating the current in either the first fixed track segment or the first transfer segment with the segment controller corresponding to either the first fixed track segment or the first transfer segment as the mover transitions between the first fixed track and the first transfer segment further comprises the steps of:
regulating the current in either the first fixed track segment or the first transfer segment for a first portion of the mover transitioning according to which of the first fixed track segment or the first transfer segment the mover is initially located;
regulating the current in either the first fixed track segment or the first transfer segment for a second portion of the mover transitioning according to which of the first fixed track segment or the first transfer segment the mover is finally located;
transmitting at least one of a current reference, a current feedback, a velocity reference, or a velocity feedback between the segment controller for each of the first fixed track segment and the first transfer segment as the mover transitions between the first fixed track segment and the first transfer segment; and
inverting at least one of the current reference, the current feedback, the velocity reference, or the velocity feedback as it is transmitted between the segment controllers with a controller when the dynamic flow for the first transfer segment is in an opposite direction of the predefined flow for the first transfer segment.

13. The method of claim 9 wherein the steps of setting the dynamic flow for the transfer segment further includes obtaining a location of the transfer segment and reading a positive direction from a look up table as a function of the location of the transfer segment.

14. A system for node management in an independent cart system, comprising:
a mover operative to generate a magnetic field corresponding to a first portion of a linear drive system for the independent cart system;
a plurality of track segments, each track segment including:
a first end,
a second end opposite the first end, wherein a length of the track segment extends between the first end and the second end and wherein a positive direction of travel is defined along the length of the track segment between the first end and the second end,
a plurality of coils positioned along the length of the track segment, and
a segment controller operative to regulate a current in each of the plurality of coils to generate an electromagnetic field corresponding to a second portion of the linear drive system;
at least one transfer segment including:
a first end,
a second end opposite the first end, wherein a length of the at least one transfer segment extends between the first end and the second end and wherein a dynamic flow selectively defines a positive direction of travel in either direction between the first and second ends of the at least one transfer segment,
a plurality of coils positioned along the length of the at least one transfer segment, and
a segment controller operative to regulate a current in each of the plurality of coils to generate an electromagnetic field corresponding to a second portion of the linear drive system;
a controller operative to:
receive a path command defining a desired motion for the mover,
define a single direction of travel for the mover,
generate a motion command for at least one track segment, selected from the plurality of track segments, in the positive direction of travel, and
set the dynamic flow for the at least one transfer segment such that the positive direction of travel is consistent with the positive direction for the at least one track segment.

15. The system of claim 14 further comprising a node controller in communication with the segment controller from the at least one transfer segment and with the segment controller from the at least one track segment, wherein the controller is the node controller.

16. The system of claim 14 wherein the controller is the segment controller from either the at least one transfer segment or the at least one track segment.

17. The system of claim 14, wherein:
the at least one track segment is a first track segment,
the at least one transfer segment is selectively moved between a first position and a second position, and
when the at least one transfer segment is in the first position, the first end of the at least one transfer segment is adjacent the second end of the first track segment and the dynamic flow is defined as positive from the first end to the second end of the at least one transfer segment, the system further comprising a second track segment, wherein when the at least one transfer segment is in the second position, the first end of the at least one transfer segment is adjacent the first end of the second track segment and the dynamic flow is defined as positive from the second end to the first end of the at least one transfer segment.

18. The system of claim 14, wherein:
the segment controller in either the at least one track segment or the at least one transfer segment regulates the current as the mover transitions between the at least one track segment and the at least one transfer segment,
a predefined flow for the at least one transfer segment is in an opposite direction as the predefined flow for the at least one track segment, and
the dynamic flow for the at least one transfer segment is in the same direction as the predefined flow for the at least one track segment.

19. The method of claim 18, wherein:
the segment controller in either the at least one track segment or the at least one transfer segment regulates the current in either the corresponding at least one track segment or the at least one transfer segment for a first portion of the mover transitioning according to which of the at least one track segment or the at least one transfer segment the mover is initially located,
the segment controller in either the at least one track segment or the at least one transfer segment regulates the current in either the corresponding at least one track segment or the at least one transfer segment for a second portion of the mover transitioning according to which of the at least one track segment or the at least one transfer segment the mover is finally located,
the segment controller in the at least one track segment is in communication with the segment controller in the at least one transfer segment,
the segment controller regulating the current transmits at least one of a current reference, a current feedback, a velocity reference, or a velocity feedback between the segment controller for each of the at least one track segment or the at least one transfer segment as the mover transitions between the at least one track segment and the at least one transfer segment; and
a controller inverts at least one of the current reference, the current feedback, the velocity reference, or the velocity feedback as it is transmitted between the segment controllers when the dynamic flow for the at least one transfer segment is in an opposite direction of the predefined flow for the at least one track segment.

20. The system of claim 14, wherein the controller is further operative to store the single direction in a look up table, wherein the look up table includes a predefined flow for the at least one transfer segment and the single direction selectively defines the dynamic flow for the at least one transfer segment.
